(19) United States
(12) Patent Application Publication
(10) Pub. No.: US 2010/0079736 A1
(43) Pub. Date: Apr. 1, 2010

(54) EXPOSURE APPARATUS AND DEVICE MANUFACTURING METHOD

(75) Inventors: Hiroyuki Wada, Utsunomiya-shi (JP); Hiromichi Hara, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/571,003

(22) Filed: Sep. 30, 2009

(30) Foreign Application Priority Data
Oct. 1, 2008 (JP) 2008-256742
Aug. 26, 2009 (JP) 2009-195393

(51) Int. Cl. G03B 27/42

(52) U.S. Cl. 355/53; 355/77; 355/75

(57) ABSTRACT

An apparatus that exposes a pattern of an original onto a plate through a projection optical system. The apparatus includes a reference base that holds the projection optical system, a supporting unit configured to elastically support the reference base, a base structure that holds the supporting unit on an installation floor, a detection unit configured to detect a relative position between the base structure and the reference base, and an adjustment unit, which is disposed at the installation floor of the base structure, configured to adjust an attitude of the base structure based on the results detected by the detection unit.

### BACKGROUND OF THE INVENTION

1. Field of the Invention

The present invention relates to an exposure apparatus and device manufacturing method.

2. Description of the Related Art

In recent years, as the capacity of a semiconductor memory increases along with the speed and integration density of a CPU processor, there is an increasing demand for an exposure apparatus that decreases the feature size of a resist pattern formed on a wafer, which a high exposure accuracy as well as a high throughput in the exposure apparatus are to be achieved. Therefore, improvements in exposure accuracy and throughput have been achieved by increasing the resolution through an increase in the numerical aperture (NA) of a projection optical system, an improvement in position controllability, or an increase in acceleration speed of a wafer stage or reticle stage, and the like.

Accordingly, in order to realize a high throughput, an exposure apparatus has been used in recent years that has a twin stage arrangement that includes two-stage movable sections arranged on a wafer stage, and performs an exposure process in an exposure sequence in parallel with a wafer alignment process. This twin stage is unavoidably enlarged in size, resulting in an inevitable increase in the size and weight of the exposure apparatus.

For example, Japanese Patent No. 3408057 discloses an exposure apparatus in which a plate supply device is separately provided from a stepper body and a lens surface plate constituting the stepper body is supported by a plurality of air mounts so as to reduce vibration transmission from the floor. With this arrangement, the exposure apparatus can provide accurate wafer handoff by correcting the relative position between the plate supply device and the lens surface plate.

In a method for installing an exposure apparatus directly on the conventional installation floor, floor subsidence may be caused by an increase in weight associated with the increased size of the exposure apparatus and a point contact between the installation leg(s) of the exposure apparatus and the installation floor due to the local topography of the floor surface.

However, in the exposure apparatus disclosed in Japanese Patent No. 3408057, since the air mount controls the attitude of the lens surface plate so as to be parallel to a floor that is locally inclined due to the floor subsidence as described above, a wafer cannot be conveyed in the correct position. In addition, when the floor subsidence occurs, it may lead to the torsion or distortion of the installation leg(s) (base structure) of the exposure apparatus. Furthermore, these factors lead to a relative positional displacement between each apparatus such as an original conveyance apparatus, plate conveyance apparatus, plate stage apparatus, illumination optical system, and the like and a projection optical system supported by the lens surface plate, resulting in performance degradation of the exposure apparatus.

To solve the issues concerning the relative position displacement, a number of relative position displacement detection mechanisms equal to the number of displacement of interest is to be used, which makes an adjustment mechanism for adjusting the relative position displacement based on these detected results more complicated. This results in a higher cost for the exposure apparatus. In addition, although the exposure apparatus has to maintain the initial installation state for many years, there is also a concern that the installation floor may change over time during long-term use.

### SUMMARY OF THE INVENTION

An apparatus exposes a pattern of an original onto a plate through a projection optical system, the apparatus has a reference base that holds the projection optical system, a supporting unit configured to elastically support the reference base, a base structure that holds the supporting unit on an installation floor, a detection unit configured to detect the relative position between the base structure and the reference base, and an adjustment unit, which is disposed at floor installation portions of the base structure, configured to adjust the attitude of the base structure based on the results detected by the detection unit.

Further features of the present invention will become apparent from the following description of exemplary embodiments with reference to the attached drawings.

### BRIEF DESCRIPTION OF THE DRAWINGS

FIG. 1 is a schematic view of an exposure apparatus according to an embodiment of the present invention.

FIG. 2 is a schematic view for explaining the periphery of an active mount.

FIG. 3 is a schematic plan view showing an arrangement of a mount displacement sensor and a gap sensor.

FIG. 4 is a schematic side view showing an arrangement of a mount displacement sensor and a gap sensor.

### DESCRIPTION OF THE EMBODIMENTS

Embodiments of the present invention will now be described with reference to the accompanying drawings.

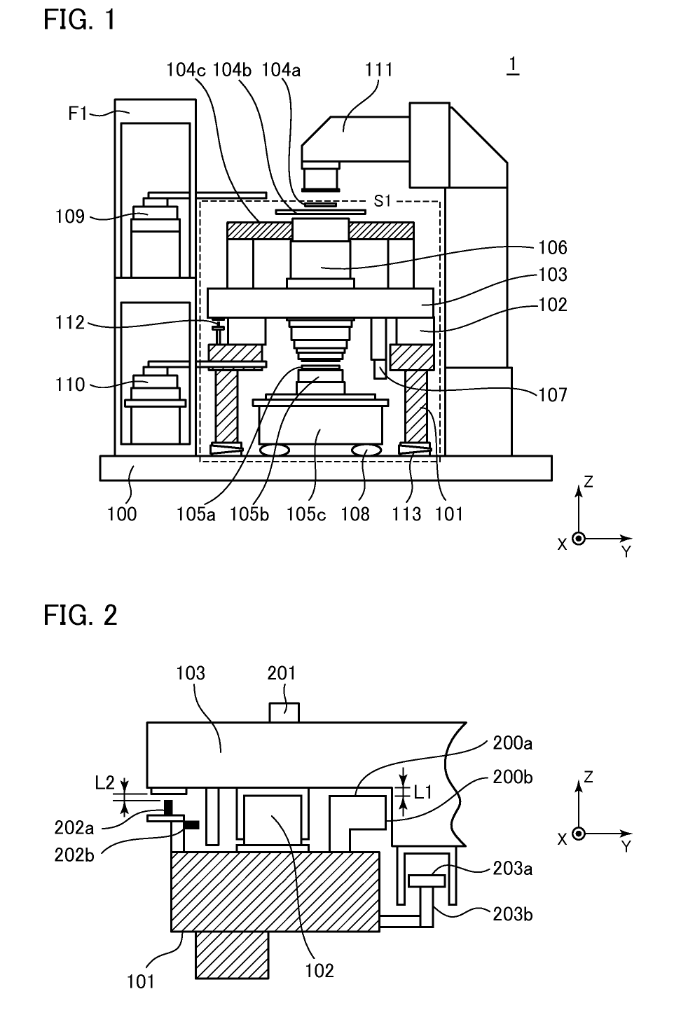

FIG. 1 is a schematic view of an exposure apparatus according to an embodiment of the present invention. Throughout the following drawings, the Z axis is taken parallel to the optical axis of a projection optical system 106 provided in an exposure apparatus 1, the Y axis is taken in the scanning direction of the reticle (original) and wafer (plate) during scanning exposure in the plane perpendicular to the Z axis, and the X axis is taken in the non-scanning direction perpendicular to the Y axis, for the purpose of explanations.

In this particular embodiment, the exposure apparatus 1 is a projection exposure apparatus that exposes a pattern of a reticle 104a onto a plate (wafer 105a) in a step-and-scan system. Note that the present invention is also applicable to an exposure apparatus in a step-and-repeat system or other exposure systems.

The exposure apparatus 1 consists of an illumination optical system 111, a stepper body S1, and a plate supply device F1, each of which is installed on an installation floor (hereinafter referred to as “floor”) 100.

The illumination optical system 111 introduces illuminating light from a built-in light source (discharge lamp such as extra high pressure mercury lamp; not shown) or a light source device installed independently of the exposure apparatus 1 through a beam line, produces slit light through various lenses or stops, and illuminates the reticle 104a from above.

The stepper body S1 includes a movable reticle stage device 104b on which the reticle 104a is mounted, and the projection optical system 106 that reduces and projects the pattern of the reticle 104a onto the wafer 105a at a predetermined magnification level (e.g., 4:1). The stepper body S1 further includes a movable wafer stage device 105b on which the wafer 105a is mounted.

The reticle stage device 104b and the projection optical system 106 are both held on a barrel surface plate (reference base) 103. The barrel surface plate 103 is installed on a base frame 101 with an active mount 102 interposed therebetween. The active mount 102 is an elastic supporting unit configured to elastically support the barrel surface plate 103, which incorporates an air spring, damper, and actuator. The active mount 102 prevents high frequency vibration from the floor 100 from being transmitted to the barrel surface plate 103, and actively compensates for any misalignment (such as tile and swing) of the barrel surface plate 103 from the detection result of the relative position between the base frame 101 and the barrel surface plate 103. The barrel surface plate 103 further includes an interferometer that detects the position of the reticle stage (not shown), and an interferometer 107 that detects the position of the wafer stage.

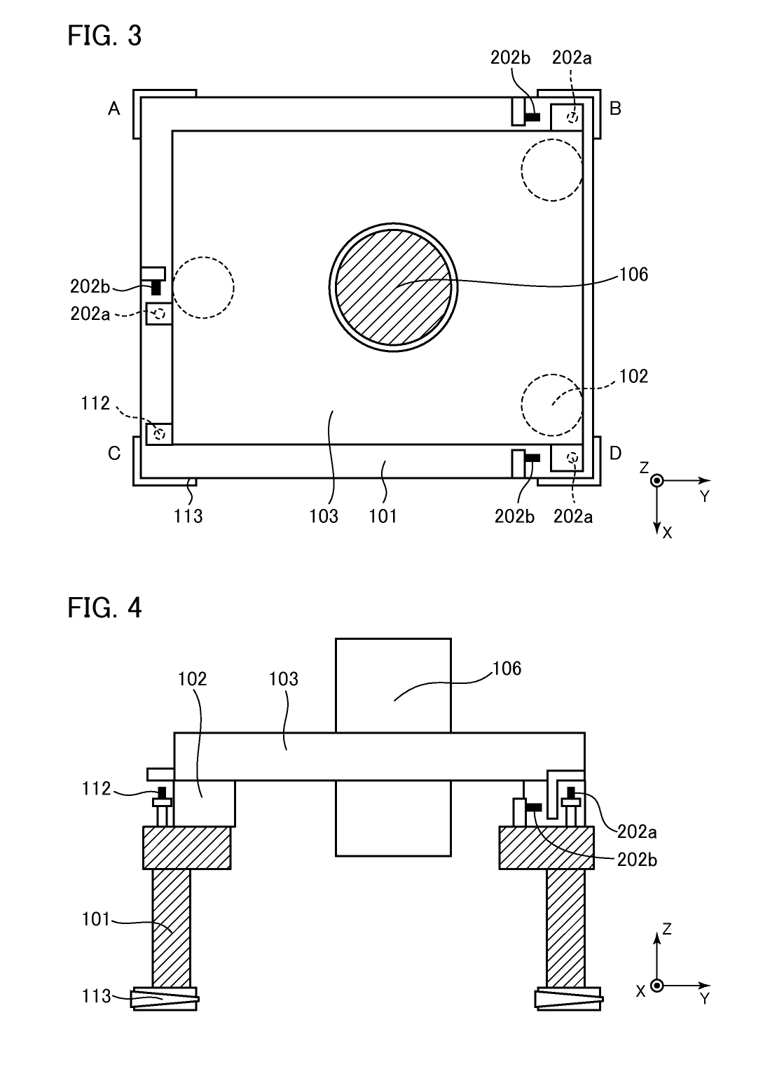

The base frame 101 is the base structure formed of a square frame as viewed from the Z axis direction, and is supported by the four leg portions (floor installation portions) at each end (see FIG. 3 to be described below). The distal end of each of the four leg portions is provided with a gap height adjustment mechanism 113 having a wedge structure, and the gap height adjustment mechanism 113 is in direct contact with the floor 100. The gap height adjustment mechanism 113 is an adjustment unit capable of adjusting the height of the base frame 101, which is used for deformation (torsion) control and attitude adjustment of the base frame caused by the subsidence or topography of the floor.

In addition, a gap sensor 112 which is a feature of the present invention is installed at one location between the barrel surface plate 103 and the base frame 101. The gap sensor 112 is a sensor (detection unit) that detects the vertical relative position of the barrel surface plate 103 with respect to the base frame 101, which detects deformation (torsion) of the base frame 101 relative to the barrel surface plate 103. The gap sensor 112 is a capacitive contactless micro-displacement meter, for example. The plane position at which the gap sensor 112 is installed is a position on the vertical line or near the vertical line of the leg portion of the base frame 101 (see FIG. 3 to be described below). In this particular embodiment, although the gap sensor 112 is installed only in the vertical direction, it may also be installed in the horizontal direction.

When a higher performance reticle stage device is applied, a reticle stage device 104c may be mounted on a structure which is not supported by the active mount 102 installed independently of the projection optical system 106 and the barrel surface plate 103 (see FIG. 1).

The wafer stage device 105b is supported on the stage surface plate 105c. The stage surface plate 105c is installed on the floor 100 through an anti-vibration support mechanism 108. Since the performance of the wafer stage device 105b has been improved in recent years, the anti-vibration support mechanism 108 may not be required to achieve a predetermined performance.

The plate supply device F1 includes a reticle supply unit 109 that automatically supplies and collects the reticle 104a, and a wafer supply unit 110 that automatically supplies and collects the wafer 105a. The plate supply device F1 is installed on the floor 100 independently of the stepper body S1. Therefore, the vibration caused by the driving of the plate carrier robot in the reticle supply unit 109 and the wafer supply unit 110 is not transmitted to the stepper body S1, and thereby the alignment of the exposure apparatus 1 and the accuracy of the positioning of each stage do not deteriorate.

FIG. 2 is an enlarged schematic view of the periphery of the active mount 102. The connection portion between the barrel surface plate 103 and the base frame 101 includes not only the active mount 102 but also a mechanical stopper 200 (which includes 200a and 200b as shown in FIG. 2), an acceleration sensor 201, a mount displacement sensor 202, and an actuator 203.

The mechanical stopper 200 is a stopper for preventing interference between units (e.g., projection optical system 106 and stage devices 104b, 105b) constituting the exposure apparatus 1 due to the barrel surface plate 103 being shaken by a disturbance vibration or the like. In this particular embodiment, the mechanical stopper 200 is placed horizontally and vertically along the base frame 101 so as to receive the load of the barrel surface plate 103. In this particular embodiment, the spacing L1 between the barrel surface plate 103 and the mechanical stopper 200 is set at 0.15 mm.

The acceleration sensor 201 is a sensor that detects vibration on the barrel surface plate 103. The mount displacement sensor 202 is a sensor (measuring unit) that measures the displacement magnitude of the barrel surface plate 103 with respect to the base frame 101. The mount displacement sensor 202 generates a control signal by the control device (not shown) based on a measurement signal, and the control signal is fed back to the active mount 102 as a reference value for the driving operation. In FIG. 2 and the following figures, it is assumed that a mount displacement sensor 202a is a sensor that measures the displacement in the vertical direction, and a mount displacement sensor 202b is a sensor that measures the displacement in the horizontal direction. In this particular embodiment, the spacing L2 between the barrel surface plate 103 and the mount displacement sensor 202a is set at 2.0 mm. As the mount displacement sensor 202, an eddy current displacement sensor, electrical capacitance displacement sensor, or displacement sensor to which a photoelectric conversion element is applied is applicable.

FIG. 3 and FIG. 4 are respectively a schematic plan view and a schematic side view showing an arrangement of mount displacement sensors 202 and a gap sensor 112. As shown in FIG. 3, the mount displacement sensors 202 are arranged at three locations in the vicinity of the active mount 102 on the base frame 101. The mount displacement sensor 202 measures a total of six axes, including three horizontal axial directions (e.g., one location at X axis, two locations at Y axis) and the three vertical axial directions (Z axis) so as to measure six degrees of freedom of the barrel surface plate 103. By the active mount 102 to be controlled and driven based on the six axis measured results, the relative distance between the barrel surface plate 103 and the base frame 101 is kept constant.

The actuator 203 is a force actuator intended for the vibration suppression of the barrel surface plate 103, which generates thrust-forces in the vertical and horizontal directions. In this particular embodiment, with respect to the vertical direction, three vertical force actuators 203a are installed, and with respect to the horizontal direction, two horizontal force actuators 203b are installed corresponding to a scanning exposure direction (Y direction) and a direction (X direction) perpendicular thereto. The number of locations where the actuators 203 to be installed and the number of the actuators 203 to be installed are not particularly limited.

Next, a method for measuring and adjusting the deformation (torsion) of the base frame 101 due to floor subsidence, which is a feature of the present invention, will be described.

In general, when the exposure apparatus 1 is newly installed on the floor 100, the leveling of the device is carried out using a leveling device, height measuring device, and the like after the installation of the exposure apparatus 1. More specifically, when the stepper body S1 is installed, the height of the leg portion of the base frame 101 is measured at four points (in FIG. 3, positions A to D) as shown in FIG. 3 by the measuring device. When an error in the height of each leg portion occurs, the stepper body S1 is installed horizontally on the floor 100 by adjusting the gap height adjustment mechanism 113 as appropriate.

Assuming now that the subsidence occurs at one of the leg portions of the base frame 101 due to prolonged use of the exposure apparatus 1, natural phenomena such as earthquakes, or change of the floor 100 through time.

In FIG. 3, let's assume that the subsidence occurs at the leg portion A. Here, a threshold value is preset in the gap sensor 112 of the present invention. That is, the gap sensor 112 initiates the control when the relative position of the barrel surface plate 103 with respect to the base frame 101 in the vertical direction exceeds the threshold value. In this particular embodiment, the threshold value is set to 0.5 mm. When the subsidence occurs at the leg portion A, the value of the gap sensor 112 installed on the leg portion C becomes a value slightly below the threshold value. Furthermore, a slight elevation occurs at the leg portion C at a position opposed to the leg portion A due to the subsidence of the leg portion A. The displacement due to the elevation can be determined by the measurement of the mount displacement sensor 202a which is installed on the leg portion C.

Therefore, the amount of the subsidence that has occurred at the leg portion A can be recognized by the measured results from the gap sensor 112 and the mount displacement sensor 202a. Such information (not shown) is displayed on the control monitor (warning unit) described above as an error message, and a warning is provided to the operator of the exposure apparatus 1. The operator who has received the warning adjusts the gap height adjustment mechanism 113 of the leg portion A based on the error message, whereby the leg portion A is returned back to the normal position. Note that the gap height adjustment mechanism 113 may be an actuator (drive unit) capable of an automatic vertical movement. In such case, the gap height control device is provided to the exposure apparatus 1 to automatically adjust the height of the leg portion A based on the error message.

Next, assume that the subsidence occurs at the leg portion B. Here, a threshold value is preset in the gap sensor 112 of the present invention in the same manner as described above. When the subsidence occurs at the leg portion B, the value of the gap sensor 112 installed on the leg portion C becomes a value significantly exceeding the threshold value. In this case, there is almost no change in the displacement measured by the respective mount displacement sensors 202a due to the subsidence of the leg portion B.

Therefore, the amount of subsidence that has occurred at the leg portion B can be recognized by the measured results from the gap sensor 112. Hereinafter, the error message display and the height adjustment at the gap height adjustment mechanism 113 are the same as those described above and no further description will be given here.

Next, assume that the subsidence occurs at the leg portion C. Here, a threshold value is preset in the gap sensor 112 of the present invention in the same manner as described above. When the subsidence occurs at the leg portion C, the value of the gap sensor 112 installed on the leg portion C becomes a value significantly above the threshold value. In this case, a slight elevation occurs at the leg portion B at a position opposed to the leg portion C due to the subsidence of the leg portion C. The displacement due to the elevation can be determined by the measurement of the mount displacement sensor 202a which is installed on the leg portion B.

Therefore, the amount of subsidence that has occurred at the leg portion C can be recognized by the measured results from the gap sensor 112 and the mount displacement sensor 202a. Hereinafter, the error message display and the height adjustment at the gap height adjustment mechanism 113 are the same as those described above and no further description will be given here.

Next, assume that the subsidence occurs at the leg portion D. Here, a threshold value is preset in the gap sensor 112 of the present invention in the same manner as described above. When the subsidence occurs at the leg portion D, the value of the gap sensor 112 installed on the leg portion C becomes a value slightly below the threshold value. In this case, there is almost no change in the displacement of the leg portion D as measured by the mount displacement sensor 202a due to the subsidence of the leg portion D itself. However, a slight elevation occurs at the leg portion B at a position adjacent to the leg portion D. The displacement due to the elevation can be determined by the measurement of the mount displacement sensor 202a which is installed on the leg portion B.

Therefore, the amount of subsidence that has occurred at the leg portion D can be recognized by the measured results from the gap sensor 112 and the mount displacement sensor 202a. Hereinafter, the error message display and the height adjustment at the gap height adjustment mechanism 113 are the same as those described above and no further description will be given here.

As is mentioned above, when the gap sensor 112 is installed on the base frame 101 and it detects a relative displacement not less than the threshold value, the attitude of the stepper body S1 is readily adjusted by the height adjustment mechanism 113 so that the relative position between the respective devices of the exposure apparatus 1 can be compensated. Specifically, a low cost and highly stable exposure apparatus can be provided by providing at least one gap sensor 112 which is a unit for measuring the deformation of the base frame 101.

Next, an embodiment of a device manufacturing method using the above-described exposure apparatus will be described.

A device such as a semiconductor element, liquid crystal display element, image sensor (e.g., CCD), thin film magnetic head, or the like is manufactured by an exposure step that exposes a plate (wafer, glass plate, and the like), on which a resist (photosensitizer) is applied, using the exposure apparatus described above; a developing step that develops the plate exposed in the exposure step; and other known steps. Examples of such known steps include at least one step selected from oxidizing, depositing, vapor depositing, doping, flattening, etching, resist removal, dicing, boding, packaging, and the like.

In this particular embodiment, the efficacy of the gap sensor 112 has been described with reference to the case where the active mounts 102 are installed at three locations on the base frame 101 as shown in FIG. 3. For example, the active mounts 102 may be installed at all of the four locations on the leg portions A to D of the base frame 101. In this case, one of the four mount displacement sensors 202 provided adjacent to the respective active mounts 102 may also be used in place of the gap sensor 112 of the present invention. With this arrangement, the same effects as those of the present invention can be obtained.

Furthermore, although, in the present embodiment, the exposure apparatus exposes a pattern of an original onto a plate through the projection optical system, the present invention is not limited thereto. The present invention may also be applied to other exposure apparatuses, for example, an exposure apparatus that exposes a pattern of an original onto a semiconductor wafer as a plate in a vacuum atmosphere, or an exposure apparatus that exposes a pattern by using an electron beam without using an original.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-256742 filed Oct. 1, 2008 and Japanese Patent Application No. 2009-195393 filed on Aug. 26, 2009 which are hereby incorporated by reference herein it their entirety.

What is claimed is:

1. An apparatus that exposes a pattern of an original onto a plate through a projection optical system, the apparatus comprising:
a reference base that holds the projection optical system;
an elastic supporting unit configured to elastically support the reference base;
a base structure that holds the supporting unit on an installation floor;
a detection unit configured to detect a relative position between the base structure and the reference base; and
an adjustment unit, which is disposed at a floor installation portion of the base structure, configured to adjust an attitude of the base structure based on results detected by the detection unit.

2. The apparatus according to claim 1, wherein the adjustment unit controls the attitude of the base structure based on the measured results from the detection unit and the measuring unit.

3. The apparatus according to claim 1, wherein the base structure comprises a measuring unit configured to measure a displacement magnitude of the base structure against the reference base, which is a reference value for controlling the supporting unit, and
the adjustment unit controls the attitude based on the measured results from the detection unit and the measuring unit.

4. The apparatus according to claim 1, wherein a threshold value is preset for the relative position, and
the adjustment unit initiates control when the relative position exceeds the threshold value.

5. The apparatus according to claim 4, further comprising:
a warning unit configured to provide a warning when the relative position exceeds the threshold value.

6. The apparatus according to claim 1, wherein the detection unit is a capacitive contactless micro-displacement meter.

7. The apparatus according to claim 1, wherein the detection unit is installed on a line vertical to a leg portion of the base structure.

8. The apparatus according claim 1, wherein the adjustment unit is a drive unit capable of automatic vertical movement.

9. The apparatus according to claim 1, wherein the adjustment units are installed at four locations and the supporting units are installed at three locations.

10. A method comprising:
exposing a plate using an apparatus that exposes a pattern of an original onto the plate through a projection optical system; and
developing the plate
wherein the apparatus comprising:
a reference base that holds the projection optical system;
a unit configured to elastically support the reference base;
a base structure that holds the supporting unit on an installation floor;
a detection unit configured to detect a relative position between the base structure and the reference base; and
an adjustment unit, which is disposed at a floor installation portion of the base structure, configured to adjust the attitude of the base structure based on the results detected by the detection unit.
